(19) United States
(12) Patent Application Publication
(10) Pub. No.: US 2010/0042917 A1
(43) Pub. Date: Feb. 18, 2010

(54) DOCUMENT PROCESSSING METHOD

(75) Inventors: KIM-YEUNG SIP, Shenzhen City (CN); MING-YUE YAN, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/494,226

(22) Filed: Jun. 29, 2009

(30) Foreign Application Priority Data
Aug. 15, 2008 (CN) 200810303848.6

(51) Int. Cl. G06F 17/24; G06F 3/048; G06F 3/01

(52) U.S. Cl. 715/255; 715/810; 715/702; 715/808

(57) ABSTRACT

A method for processing a document, including receiving an operation, detecting whether an object in the document is chosen by the received operation, popping up a menu including menu options corresponding to the chosen object, detecting whether a selection operation is selected, and performing a corresponding operation according to the selection operation.

### BACKGROUND

1. Technical Field

The disclosure relates to a document processing method.

2. Description of Related Art

In general, users can select an object on a display, such as a word or phrase, in a document by using a pointing device, such as a mouse, to click and drag over the object, thus highlighting the object. Once highlighted, operations may be performed on the object. For example, a right click of the mouse may activate or open a menu including several menu options, such as cut, copy, and so on. Although, the above method works, it is a complex operation.

Therefore, what is needed is a quick and easy to use document and menu navigation method.

### BRIEF DESCRIPTION OF THE DRAWINGS

FIG. 1 is a flowchart of a method for processing documents on a touch screen implemented by a central processing unit (CPU) in accordance with one embodiment.

FIG. 2 is a schematic diagram showing a window when documents are processed on a touch screen in accordance with one embodiment.

### DETAILED DESCRIPTION

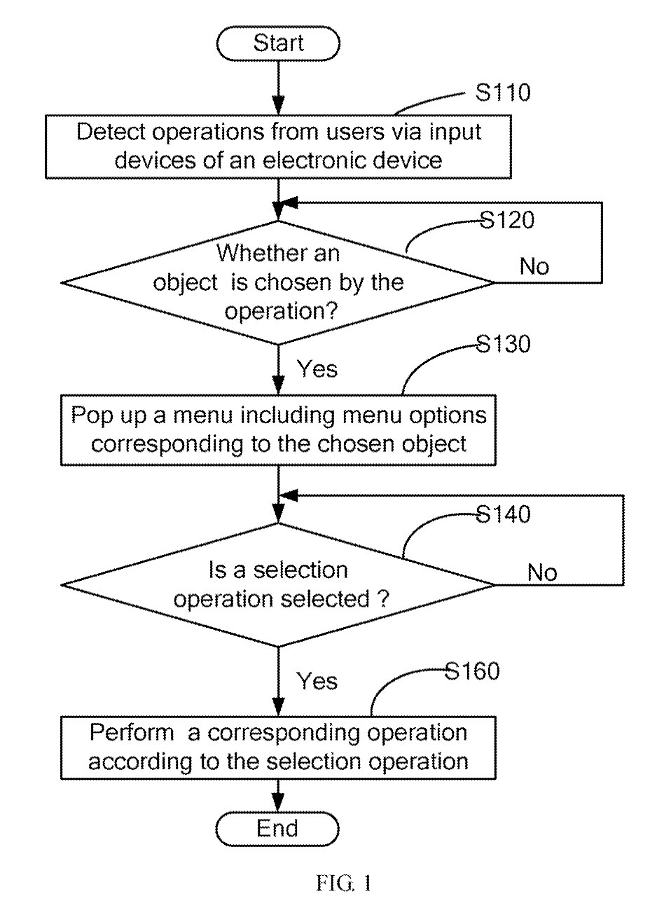

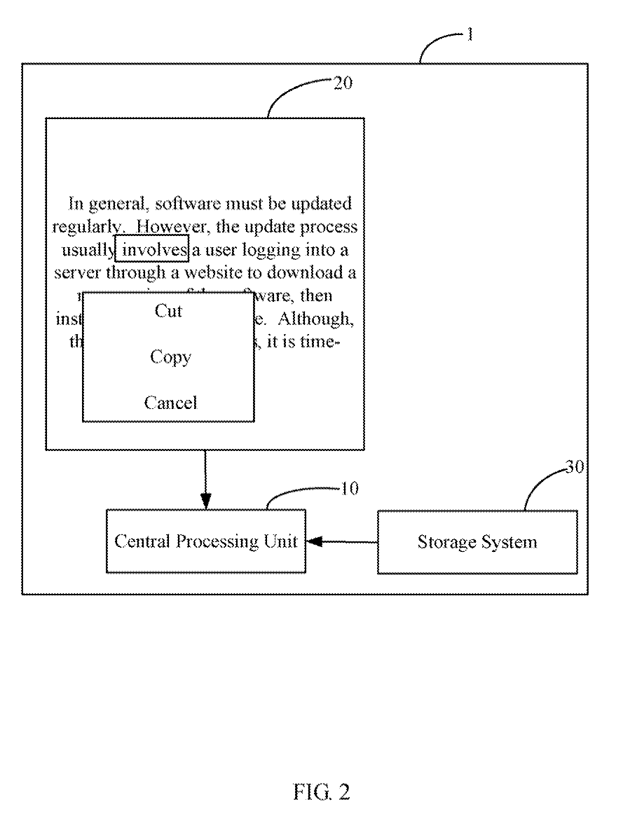

FIG. 1 is a flowchart of a method for processing documents on a touch screen 20 (shown in FIG. 2) implemented by a CPU 10 (shown in FIG. 2) executing one or more programs stored in a storage system 30 (shown in FIG. 2) of an electronic device 1 (shown in FIG. 2) in accordance with one embodiment. FIG. 2 is a schematic diagram showing a window when documents are processed on a touch screen 20 in accordance with one embodiment. FIG. 2 will be described together with FIG. 1 in the following disclosure.

In step S110, The CPU 10 of the electronic device 1 detects operations from users via input devices of the electronic device 1. Therein, the input devices may be a mouse, a touch pen, a combination of the mouse and the touch pen, or a finger.

In step S120, the CPU 10 detects whether an object in a document is chosen by the received operation; if not, the method returns to step S110. The chosen object in the document may be: words, images, links, and so on, or a combination thereof. As shown in FIG. 2, the chosen object is a word “involves.” When an object is chosen, it may be highlighted in any of many different ways, such as framed in a box in this example.

In step S130, if an object in a document is chosen by the operation, the CPU 10 pops up on the touch screen 20, a menu including many menu options for the chosen object on the touch screen 20. The menu corresponds to one or more programs stored in the storage system 30. As shown in FIG. 2, the menu options in this example include cut, copy, and cancel. For other types of objects and in other embodiments, the menu can include additional or different menu options, such as, insert, send, go to, and so on.

In step S140, the CPU 10 detects whether a selection operation is selected by the users; if not, the method returns to step S130.

In step S160, if a selection operation is selected, the CPU 10 performs an operation on the highlighted object according to the selection operation. As shown in FIG. 2, if the selection operation is cut, the CPU 10 will cut the chosen object “involves,” and save the cut object to a system clipboard. If the selection operation is copy, the CPU 10 will copy the chosen object “involves,” and save the copied object to the system clipboard. If the selection operation is cancel, the menu will disappear and the highlighted object is no longer highlighted so another object can be selected.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. A computer-implemented method for processing a document, in an electronic device, the method comprising:
providing the electronic device, the electronic device comprising a touch screen, a central processing unit (CPU), a storage system comprising one or more programs to be executed by the CPU;
displaying the document on the touch screen;
detecting whether an object in a document is chosen by an operation;
popping up a menu corresponding to the one or more programs, if an object in the document is chosen by the received operation, the menu including menu options for the chosen object on the touch screen;
detecting whether a selection operation is selected;
performing an operation on the highlighted object according to the selection operation if a selection operation is selected.

2. The method as described in claim 1, further comprising highlighting an object when an object is chosen.

3. The method as described in claim 1, further comprising saving the chosen object to a system clipboard after a corresponding operation is performed for the chosen object.

4. The method as described in claim 1, wherein the chosen object in the document is selected from the group consisting of words, images, links, and a combination thereof.

5. The method as described in claim 1, wherein the input devices is selected from the group consisting of a mouse, a touch pen, and a combination of the mouse and the touch pen.

6. The method as described in claim 1, wherein the menu options comprises cut, copy, and cancel.
